(19) United States
(12) Patent Application Publication
(10) Pub. No.: US 2010/0170574 A1
(43) Pub. Date: Jul. 8, 2010

(54) GAS MIXING PUMP WITH VARIABLE INJECTION SECTION

(75) Inventors: Stephane Fauque, Toulouse (FR); Christine Stephan, Verfeil (FR)

Correspondence Address: YOUNG & THOMPSON, 209 Madison Street, Suite 500, Alexandria, VA, 22314, US

(73) Assignee: LIEBHERR-AEROSPACE TOULOUSE SAS, TOULOUSE (FR)

(21) Appl. No.: 12/601,626

(22) PCT Filed: May 20, 2008
(86) PCT No.: PCT/FR08/00698

§ 371 Date: Nov. 24, 2009

(30) Foreign Application Priority Data
May 25, 2007 (FR) 07 03717

(51) Int. Cl. G05D 11/13; F04B 49/22

(52) U.S. Cl. 137/101.19; 417/307

(57) ABSTRACT

The invention relates to a pump including: a gas mixing housing (1); ducts (2, 3) for supplying the housing (1) with HP and IP gases and giving into the mixing housing (1); an outlet duct (3) for the mixed gases; a pneumatic actuator (10) provided in the HP-gas supply duct (2) including a mobile piston connected to a stopper (12) whose position in the duct (2) determines a passage section of the HP gas towards the mixing housing (1); a control chamber (13) of the mobile piston adapted to be fed under pressure for determining the position of the mobile piston; a pneumatic circuit provided between a pressure source and the control chamber (13); characterised in that the pneumatic circuit includes at least one leak valve (22) adapted for generating a leak in the pneumatic circuit for modifying the pressure supplied to the control chamber (13).

The invention relates to a gas—in particular air—mixing pump with variable injection section.

An air mixing pump is used, for example, in air conditioning systems of aircraft to supply a flow of air at constant pressure at the pump outlet, from two air flows at different pressures.

A pump with variable injection section is already known (cf. for example US 2003/0205049) comprising:
an air mixing housing,
giving into the mixing housing, a first duct for supplying the housing with air, known as HP air, brought to a first pressure,
giving into the mixing housing, a second duct for supplying the housing with air, known as IP air, brought to a second pressure, said second pressure being lower than said first pressure,
a pneumatic actuator comprising a mobile piston arranged in the first duct for supplying HP air, the mobile piston being designed to be displaced between a position, known as the closed position, in which it prevents the circulation of HP air to the mixing housing, and a position, known as the open position, in which it permits the circulation of HP air to the mixing housing.

Such a pump makes it possible to modify the quantity of HP air supplied to the mixing housing so as to be able to obtain, at the pump outlet, air mixed at constant pressure, whatever the flight phase of the aircraft, i.e. whatever the values of the air pressure in the HP and IP ducts.

Moreover, such a pump makes it possible to limit the quantity of HP air drawn from the principal engines of the aircraft, and thus in particular, to improve the performance and reliability of the principal engines, to limit the consumption of fuel and to improve the overall performance of an aircraft equipped with such a mixing pump.

The air pressure at the outlet of the mixing housing depends on the proportions of HP and IP air supplied to the mixing housing. These proportions depend on the position of the mobile piston in the duct for supplying the housing with HP air. The value of the pressure at the pump outlet depends, therefore, directly on the position of the mobile piston in the duct for supplying HP air.

According to US 2003/0205049, the position of the mobile piston of the pneumatically controlled actuator in the duct for supplying the housing with HP air is regulated automatically by the pressure of the mixed air which is present at the outlet of the mixing housing. To achieve this, US 2003/0205049 provides a mobile piston displaceably driven by an actuator which comprises an actuator body designed to ensure the guidance of the mobile piston. Said actuating body also comprises a closing chamber supplied by air drawn from the outlet of the mixing housing by means of a feedback duct arranged between the outlet of the mixing housing and said closing chamber. The actuator also comprises a closing spring arranged between the mobile piston and the actuator body, and an exhaust. Henceforth, the mobile piston has, at any moment, a position of equilibrium resulting in particular from the pressure of the closing chamber, the stiffness of the spring, the dimensions of the exhaust, etc.

Such a pump makes it possible to obtain constant nominal pressure at the pump outlet, irrespective of the values of the pressures of the air circulating in the ducts for supplying the mixing housing with HP air and IP air.

Moreover, such a pump makes it possible to limit automatically the use of HP air when the nominal pressure is reached due to a displacement of the mobile piston toward the closed position, activated by the air drawn from the pump outlet.

Finally, such a pump and in particular the pneumatic actuator make it possible, on the one hand, to withstand temperatures of the HP air drawn from the engines which may reach 500° C. and, on the other hand, to use the available energy resources which make it possible to limit the use of HP air drawn from the engines when the air pressure at the pump outlet has reached a nominal value.

In contrast, such a known pump may not be controlled to supply a pressure at the outlet of the mixing housing which is different from the nominal pressure. This pressure depends on the cross section of the ducts, the stiffness of the spring of the actuator and generally all the characteristics of the pump. In other words, a pump according to US 2003/0205049 has to be dimensioned during its manufacture to permit the provision, at the pump outlet, of air which has, irrespective of the value of the HP and IP pressures, a specific nominal pressure, which is subsequently not adjustable. The applications of such a pump are thus limited to the specific applications for which it has been dimensioned.

Moreover, the available pressure at the pump outlet depends strictly on the characteristics of the pump—cross section of the ducts, stiffness of the spring, dimension of the exhaust, etc. These characteristics are determined in the engineering and design department, for example, by creating virtual models. Any variation between a theoretical characteristic and the corresponding actual characteristic, results in a modification of the nominal pressure actually obtained at the pump outlet. In other words, such a pump does not have good tolerance as regards its characteristics.

The invention aims to remedy these drawbacks and to propose a gas mixing pump with variable injection section with which it is possible to modify the value of the air pressure delivered at the pump outlet according to a reference value.

The invention also aims to propose such a pump which delivers at the pump outlet an air pressure, irrespective of the values of the supply pressures of the pump.

The invention also aims to propose a gas mixing pump with variable injection section which has good tolerance as regards its characteristics.

The invention also aims to propose such a pump which may be installed and adapted to mounting on all types of aircraft.

The invention also aims to propose such a pump which may be supplied by gases at very high temperature.

The invention also aims to provide a pump with variable injection section which may be manufactured in series and adjusted when mounted on all types of aircraft.

The invention also aims to provide a pump with variable injection section which may permit fine and accurate adjustment of the pressure at the pump outlet.

To achieve this, the invention relates to a gas—in particular air—mixing pump with variable injection section comprising:
a gas mixing housing,
giving into said mixing housing, a first duct for supplying said housing with a gas, known as HP gas, brought to a first pressure,
giving into said mixing housing, a second duct for supplying said housing with a gas, known as IP gas, brought to a second pressure which is different from said first pressure,
connected to said housing, an outlet duct for the mixed gases, known as outlet gas, via said mixing housing, said outlet gas having an intermediate pressure between said first pressure and said second pressure which depends on the proportions of HP gas and IP gas delivered to said mixing housing,
a pneumatic actuator arranged in said first HP gas supply duct, said actuator comprising:
a mobile piston connected to a stopper whose position in said supply duct determines the passage section of the HP gas toward said mixing housing, a variation in the position of said piston causing a variation in said passage section,
a control chamber of said mobile piston fed under pressure via a pressurization duct, the pressure prevailing in the control chamber determining the position of said mobile piston,
a pneumatic circuit, known as the power circuit, provided between a pressure source, known as the first pressure source, and the pressurization duct, the power circuit being designed to deliver a pressure, known as the control pressure, to the control chamber via the pressurization duct,
   wherein the power circuit comprises at least one leak valve arranged between the first pressure source and the pressurization duct, adapted for generating a leak in the power circuit with an adjustable leak rate, the value thereof determining the pressure delivered to the control chamber of the actuator.

A pump according to the invention makes it possible to modify the HP/IP proportions of the gas mixture in the mixing housing by acting on the pressure delivered to the control chamber of the actuator. This pressure is delivered by a power circuit comprising a leak valve adapted for generating a leak in the power circuit which makes it possible to adjust the value of the pressure delivered to the control chamber of the pneumatic actuator, and thus the value of the pressure of the gas mixture present at the pump outlet.

Advantageously and according to the invention, said leak valve is designed to be displaced between at least one position, known as the open position, and at least one position, known as the closed position, the pressure delivered via the power circuit to the control chamber of said actuator being lower when said leak value is in the open position than when said leak valve is in the closed position.

If the pressure at the pump outlet has to be reduced, the leakage of the power circuit may be reduced—by placing the leak valve in the closed position—so that the pressure delivered to the control chamber of the pneumatic actuator is increased, which inflates said control chamber and causes a displacement of the mobile piston to a position in which the passage section of the HP gas is reduced by the stopper, thus limiting the quantity of HP air delivered to the mixing chamber. The new mixture, at the pump outlet, thus has a proportion of HP gas which is lower than before the closure of the leak valve, which leads to a reduction in the pressure of the mixture. In turn, if the pressure at the pump outlet has to be increased, the leakage from the pneumatic circuit may be increased—by placing the leak valve in the open position—so that the pressure delivered to the control chamber of the actuator is reduced, which deflates this control chamber and causes a displacement of the mobile piston to a position in which the passage section of the HP gas is enlarged, thus increasing the quantity of HP air delivered to the mixing chamber. The new mixture, at the pump outlet, thus has a proportion of HP gas which is greater than before the opening of the leak valve, which leads to an increase in the pressure of the mixture.

Advantageously and according to the invention, said leak valve is designed to be displaced between a closed position, known as the fully closed position, in which the pressure delivered to the control chamber is the pressure of said first pressure source, and an open position, known as the fully open position, corresponding to the maximum opening of the leak valve.

A pump according to the invention provided with a pneumatic circuit for supplying the control chamber of the pneumatic actuator which comprises at least one leak valve, thus makes it possible to deliver a parameterable reference pressure at the pump outlet.

A pneumatic circuit of a pump according to the invention may comprise one or more leak valves. Each leak valve may be produced with various shapes and structures. A leak valve according to the invention may be an on/off leak valve or a proportional valve.

However, advantageously and according to the invention, at least one leak valve is a proportional valve designed to be able to be displaced continuously between an open position, known as the maximum open position and said closed position, so as to allow continuous variations in the leak rate.

A pump according to this variant of the invention makes it possible to change continuously and accurately the leak rate generated by such a leak valve, which makes it possible to adjust continuously and accurately the pressure delivered to the control chamber of the actuator, and thus to position continuously and accurately the stopper in the duct for supplying HP gas. The gas mixture obtained at the pump outlet may thus be accurately metered with HP gas and IP gas, which makes it possible to obtain a specific pressure, which is able to adopt any value and is continuously adjustable in the interval between a value close to the HP gas pressure and the IP gas pressure.

The gas at the pump outlet may have a pressure equal to the pressure of the IP gas by completely obstructing the duct for supplying HP gas. In contrast, as the duct for IP gas is not able to be obstructed, the maximum pressure which such a pump may deliver at the pump outlet is lower than the value of the HP gas pressure.

The opening and closing of a leak valve may be provided by different mechanical, pneumatic, electrical means, etc.

Advantageously, a pump according to the invention comprises an electric motor designed to permit displacements of said leak valve between said fully open position and said fully closed position and vice versa.

Advantageously a pump according to the invention comprises:
a pressure sensor arranged at the pump outlet and designed to deliver a signal, known as the pressure measuring signal, representative of the pressure of said outlet gas,
an electric control unit designed to receive a reference signal representative of a reference pressure value which the pump has to supply at the pump outlet and the pressure measuring signal delivered by the pressure sensor, said electric control unit being designed to supply the electric motor with a command designed to cause an opening/closing of said leak valve(s), so as to modify the value of the pressure delivered to the control chamber so that the stopper may be displaced in the duct for the supply of HP gas and that the pump supplies, at the pump outlet, an outlet gas at said reference pressure.

Such a pump comprising an electric control unit designed to receive a reference pressure and a measurement of the pressure at the pump outlet makes it possible to evaluate a motor command to be transmitted to the electric motor so that the motor causes a displacement of each leak valve which permits the pump to provide, at the pump outlet, a gas mixture at the reference pressure.

Such a pump thus makes it possible to adjust the pressure at the pump outlet. This adjustment may be fine and accurate by the use of an electric motor designed to cause directly or indirectly each leak valve to open and close.

A pump according to this embodiment thus comprises an electric motor and an electric control making it possible to adjust the pressure delivered by this pump, including if it is subjected to temperatures in the order of 500° C. This has been made possible by separating the electric control from the pneumatic control. In particular, the power circuit delivers a pressure to the control chamber of the pneumatic actuator. This power circuit has a leak valve with a flow rate which is adjustable by adjusting the leak cross section. This leak cross section is controlled, directly or indirectly, by an electric motor. Henceforth, the electric motor is not directly subjected to a hostile environment, in terms of the pressure and temperature of the mixing pump.

A pump according to this variant is controlled in its pressure. However, there is nothing to prevent a temperature control being provided.

To achieve this, advantageously, a pump according to the invention comprises:
a temperature sensor arranged at the pump outlet and designed to deliver a signal, known as the temperature measuring signal, representative of the temperature of said outlet gas,
an electric control unit designed to receive a reference signal representative of a reference temperature value which the pump has to provide at the pump outlet and the temperature measuring signal delivered by the temperature sensor, said electric control unit being designed to supply the electric motor with a command designed to cause an opening/closing of said leak valve(s), so as to modify the value of the pressure delivered to the control chamber such that said stopper may be displaced in said first duct, and so that the pump provides, at the pump outlet, an outlet gas at said reference temperature.

According to a further variant, a pump may comprise both a pressure sensor and a temperature sensor and the control unit may evaluate a command depending on the temperature and pressure measurements.

Advantageously and according to the invention, said leak valve is a three-way valve: a first port connected to said pressurization duct; a second port connected to said first pressure source; and a third port connected to a leakage reservoir, at a pressure which is lower than the pressure of said first pressure source.

Such a three-way leak valve makes it possible to change the value of the pressure delivered to the control chamber of the actuator between two pressure values.

Advantageously and according to the invention, said three-way leak valve comprises a check valve designed to be displaced continuously between a position corresponding to said fully closed position in which said first port is in direct communication with said second port, so that the pressure delivered to said control chamber is the pressure of said first pressure source and a position, corresponding to said fully open position, in which the first port is in direct communication with the third port so that the pressure delivered to the control chamber is the pressure of said leakage reservoir.

Advantageously and according to the invention, said electric motor is designed to permit a displacement of said check valve so as to ensure a variation in said pressure delivered to said control chamber of said actuator, which is an intermediate pressure between the pressure of said first pressure source and the pressure of said leakage reservoir.

According to this variant of the invention, the position of the leak valve is determined by the position of a check valve arranged inside the leak valve. The displacement of this check valve is determined by the electric motor.

The electric motor may act directly on the check valve or act indirectly on the check valve by means of a control circuit or form part of a control circuit of the leak valve.

Advantageously, a pump according to the invention comprises a control circuit of said leak valve, said control circuit comprising a pneumatic regulator comprising:
a membrane delimiting two chambers, a regulating chamber designed to be supplied with pressure, known as the regulating pressure, and a calibrating chamber comprising a calibrated spring connected to said membrane, the position of equilibrium of said membrane depending on said regulating pressure and the stiffness of said calibrated spring,
a rigid rod connected to said member and to said check valve of said leak valve, so that a displacement of said membrane causes a displacement of said check valve.

The displacement of the membrane results from the equilibrium between the force delivered by the calibrated spring and the pressure exerted by the regulating pressure.

The equilibrium of the membrane defines the position of the check valve of the leak valve. The position of the check valve defines the control pressure delivered to the control chamber.

A regulator of a pump according to the invention may be a single-action regulator or a dual-action regulator.

Advantageously and according to the invention, the control circuit of said leak valve comprises:
a pressure source, known as the third pressure source,
at least one duct arranged between said third pressure source and said regulating chamber and designed to deliver to said regulating chamber a pressure, known as the regulating pressure,
at least one leak valve designed to generate a leak in said duct which makes it possible to vary said regulating pressure delivered to said regulating chamber.

The leak valve of the control circuit may, similar to the leak valve of the power circuit for supplying the control chamber of the actuator, be produced by different structures.

Advantageously and according to the invention, said leak valve of said control circuit is formed by an orifice made in a duct and by a mobile vane arranged opposite said orifice, a displacement of said vane ensuring a variation of said regulating pressure delivered to said regulating chamber.

The principle of delivering a regulating pressure to the regulating chamber of the regulator is identical to the principle of delivering a control pressure to the control chamber of the actuator. In particular, said control circuit comprises a leak valve arranged between a pressure source and the regulating chamber, said leak valve of the control circuit being adapted for generating a leak in the control circuit, which makes it possible to modify the value of the pressure delivered to the regulating chamber.

Said leak valve of the control circuit is preferably implemented by a system of the nozzle/vane type.

Advantageously and according to the invention, said electric motor is designed to ensure, upon a command from said control unit, a displacement of said vane which makes it possible to vary the pressure delivered to said regulating chamber of said regulator so as to permit an opening/closing of said leak valve.

According to this advantageous variant, the electric motor directly drives the vane in rotation. Said vane is preferably fixed to the shaft of the electric motor.

The control circuit comprises a specific number of ducts arranged between said third pressure source and the regulating chamber of the regulator. According to this variant of the invention, said control circuit comprises an orifice made on one of the ducts, said orifice being obstructed at least partially by a vane. The displacement of the vane makes it possible to vary the leak cross section of the control circuit, and thus to vary the regulating pressure delivered to said regulating chamber.

According to this variant of the invention, the electric motor comprises a shaft on which the vane is arranged. A rotation of the shaft of the electric motor causes a pivoting of the vane, which makes it possible to increase or reduce the cross section of this leak and thus to reduce or increase the pressure delivered to the regulating chamber.

Henceforth, the control of the leak valve of the power circuit is the result of the following steps: the electric motor modifies the position of the vane of the control circuit; this modification of the position causes a modification of the value of the regulating pressure delivered to the regulating chamber; this modification of the pressure value causes a displacement of the membrane of the regulator; the displacement of the membrane causes a displacement of the check valve of the leak valve of the power circuit connected to this membrane.

The electric control unit of a pump according to the invention which is designed to receive a reference pressure and a measurement of the pressure at the pump outlet, may moreover evaluate a motor command to be transmitted to the electric motor.

The electric motor of a pump according to the invention may be of any type.

However, advantageously and according to the invention, said electric motor is a continuous current torque motor. The control of such a torque motor is particularly simple. The control unit transmits a reference current to said motor, which causes a rotation of the drive shaft, and thus a variation of the leak cross section.

In a pump according to the invention comprising a power circuit designed to deliver a pressure to the control chamber of the actuator and comprising a leak valve, and a control circuit designed to control the position of this leak valve, the power and the control are separated.

This separation has a specific number of advantages which was not possible with pumps of the prior art. In particular, the separation of the pneumatic control from the pneumatic power makes it possible, in particular, to have a control circuit comprising a control gas at lower pressure than the pressure of the power gas intended to supply the chamber of the actuator. This lower pressure makes it possible to use a single electric motor which creates a limited power, which would not be the case if the electric motor were confronted with pressures of the power gas which supplies the chamber of the actuator. Such a separation also makes it possible for the differences in pressure of the HP and IP gases, which circulate in the ducts of the pump, to be irrelevant. Generally, a pump according to the invention is fitted on an aircraft and the HP gas is air drawn from the engines of this aircraft.

Henceforth, the HP air is sensitive to the variations of the engine speed.

The third source of pressure supplying the control circuit may be of any type.

However, advantageously and according to the invention, said third pressure source of said control circuit is supplied by a pressure reducing valve designed to supply a predetermined pressure, from gas drawn from the pump outlet.

The pressure sources—a high pressure and a low pressure source—which permit the three-way valve to deliver to the control chamber of the pneumatic actuator an intermediate pressure which is between the high pressure and the low pressure, may be of any type.

Advantageously and according to the invention, said pressure sources connected to said three-way valve are ambient air and said HP gas.

According to this variant, the source of high pressure is the HP gas and source of low pressure is ambient air.

The pneumatic actuator of a pump according to the invention may be of any type.

Preferably, said actuator is a single-action pneumatic actuator.

Advantageously and according to the invention, said pneumatic actuator comprises:
an actuator body bearing said mobile piston stopper, said actuator body comprising means for guiding the mobile piston,
delimited by said actuator body and said mobile piston, said control chamber,
delimited by said actuator body and said mobile piston, opposing said control chamber, a second chamber designed to be supplied with said HP gas,
a closing spring arranged in said control chamber and designed to exert on said mobile piston a force which cooperates with the pressure of the control chamber to displace the mobile piston.

The closing spring makes it possible essentially to cooperate with the control pressure delivered to the control chamber to ensure the displacement operations of the mobile piston.

A pump according to the invention may have various shapes and dimensions. Similarly, the ducts for supplying the mixing housing with HP gas and IP gas may have various shapes and dimensions.

Advantageously and according to the invention, said ducts for supplying HP gas and IP gas open concentrically into said mixing housing.

To achieve this, the duct for supplying the mixing housing with HP gas is housed inside the duct for supplying the housing with IP gas. Henceforth, the cross section of the duct for supplying IP gas is annular.

Such an architecture makes it possible to limit the space taken up by a pump with variable injection section and to promote the mixing of gas at the inlet in the mixing housing.

Advantageously and according to the invention, said duct for supplying said mixing housing is conical and said stopper rigidly connected to said mobile piston of the pneumatic actuator is a conical needle valve which extends into said conical supply duct.

Such a cooperation of shape makes it possible to vary the HP gas injection section in the mixing housing.

A mixing pump according to the invention is particularly intended to be fitted in an air conditioning system of an aircraft.

Henceforth, advantageously and according to the invention, said HP gas is high pressure air drawn from the engines of an aircraft and said IP gas is air at internal pressure drawn from the cabin of the aircraft.

The invention further relates to a pump with variable injection section, characterized in combination by all or some of the features mentioned above or below.

Further features, objects and advantages of the invention will appear from reading the following description which presents by way of non-limiting example an embodiment of the invention, with reference to the accompanying drawings, in which:

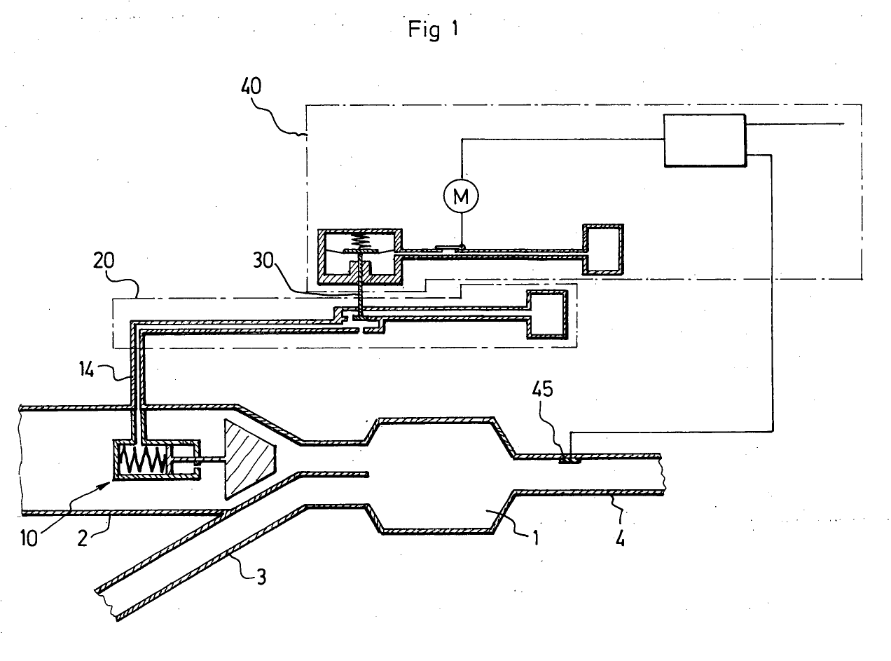

FIG. 1 is a schematic view of a pump according to an embodiment of the invention comprising an actuator, a leak valve and a control circuit of said leak valve,

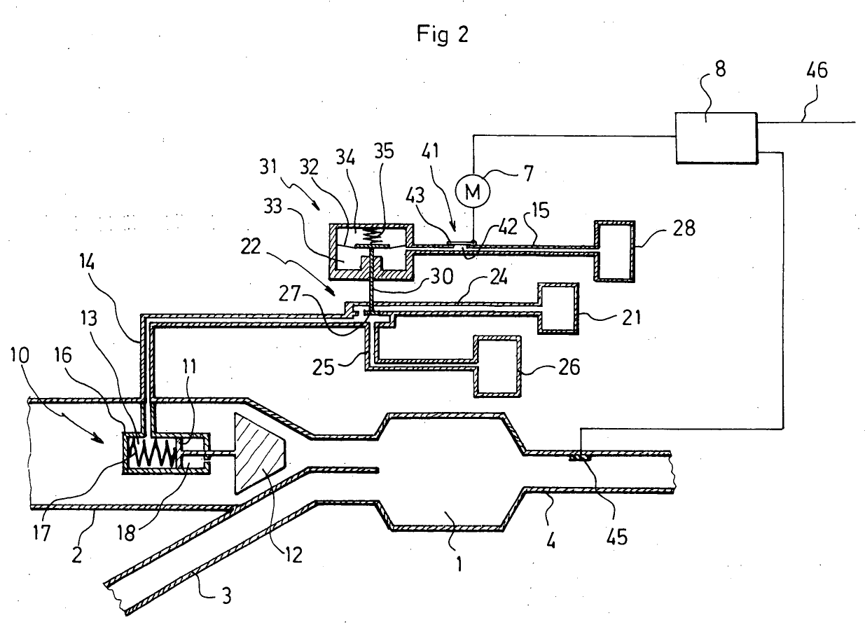

FIG. 2 is a schematic view of a pump according to a further embodiment of the invention,

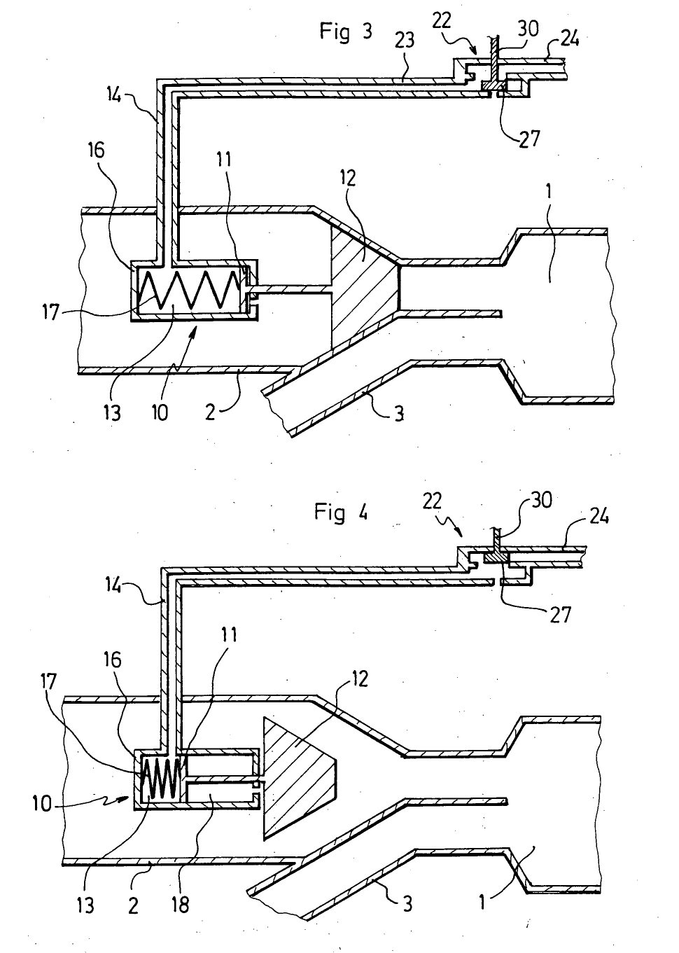

FIG. 3 is a schematic view of an actuator and of a leak valve of a pump according to an embodiment of the invention of which the leak valve is in an open position,

FIG. 4 is a schematic view of an actuator and of a leak valve of a pump according to an embodiment of the invention of which the leak valve is in a closed position,

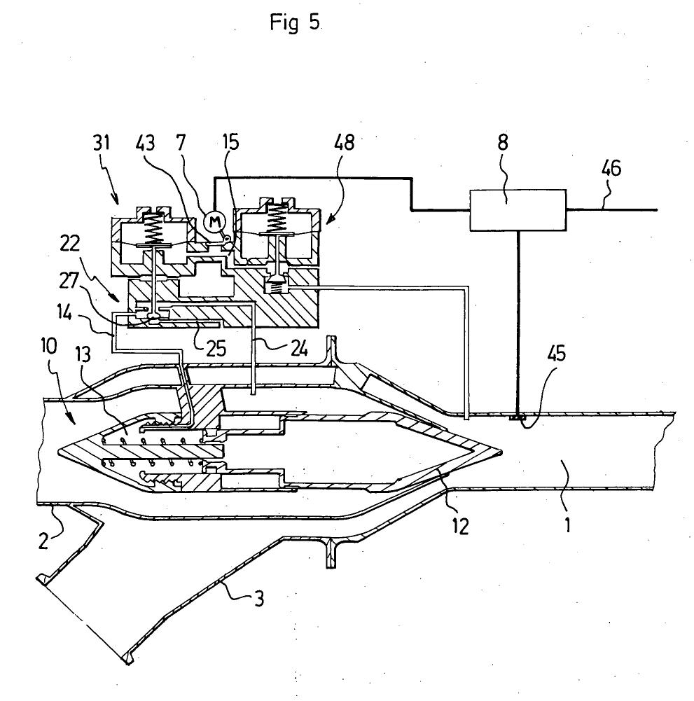

FIG. 5 is a schematic view of a pump according to a further embodiment of the invention.

A pump according to the invention comprises, as shown in FIG. 1, a gas mixing housing 1. Said gas mixing housing 1 is supplied with high pressure gas, known as HP gas, via a duct 2 which opens into the housing 1, and a low pressure gas, known as IP gas, via a duct 3 which opens into the housing 1.

The mixing housing 1 delivers, at an outlet duct 4, an outlet gas, resulting from the mixture of the HP and IP gases delivered to the mixing housing 1 via the ducts 2, 3. Said outlet gas delivered by the outlet duct 4 is at an intermediate pressure between the IP and HP pressures.

A pump according to the invention further comprises a pneumatic actuator 10 arranged in the duct 2. Said pneumatic actuator 10 comprises a mobile piston 11 fixed to a stopper of which the position in the duct 2 determines the passage section of HP gas toward the mixing housing 1. A variation in the position of the piston 11 causes a variation of this passage section. The actuator 10 further comprises a control chamber 13 of the mobile piston 11.

This control chamber 13 is adapted to be fed under pressure via a pressurization duct 14. The pressure prevailing in said control chamber 13 determines the position of the mobile piston 11, and thus the position of the stopper 12 in the duct 2. As a variation in the position of the stopper 12 causes a variation in the passage section of HP air toward the housing, and thus a variation in the pressure of the outlet gas, the pressure prevailing in the control chamber 13 determines the pressure of the outlet gases.

A pump according to the invention further comprises a pneumatic circuit, known as the power circuit 20, arranged between a pressure source, known as the first pressure source 21, and said pressurization duct 14. Said power circuit 20 is designed to deliver a pressure, known as the control pressure, to the control chamber 13 via the pressurization duct 14.

Said power circuit 20 comprises at least one leak valve 22 arranged between the first pressure source 21 and the pressurization duct 14. Said leak valve 22 is adapted for generating a leak in the power circuit 20 which makes it possible to modify the pressure delivered to the control chamber 13 of the actuator 10.

The leak valve 22 of the power circuit 20 may be of any known type. However, preferably, the leak valve 22 is a proportional valve, for example a three-way proportional valve. Said three-way proportional valve 22 comprises, as shown in the figures, a first port 23 connected to the pressurization duct 14; a second port 24 connected to the first pressure source 21; and a third port 25 which is used as a leakage port.

Said third port 25 may open, as shown in FIG. 1, into the ambient atmosphere which prevails around the leak valve 22.

According to a further embodiment as shown in FIG. 2, said third port 25 may be connected to a leakage reservoir 26, at lower pressure than the pressure of the first pressure source. Said leakage reservoir 26 is used as a second pressure source.

Henceforth, a leak valve 22 of a pump according to this embodiment may deliver a pressure to the control chamber 13 of the pneumatic actuator 10, namely an intermediate control pressure between the pressure of the first pressure source 21 and the pressure of the leakage reservoir 26.

The control of the three-way leak valve 22 is preferably transmitted via a check valve 27 designed to be displaced continuously between a position, corresponding to a fully closed position of the leak valve 22, in which the first port 23 is in direct communication with the second port 24, and a position, corresponding to a fully open position of the leak valve 22, in which the first port 23 is in direct communication with the third port 25.

When the leak valve 22 is in the fully closed position, the pressure delivered to the control chamber 13 is the pressure of the first pressure source 21.

When the leak valve 22 is in the fully open position, the pressure delivered to the control chamber 13 is the pressure of the leakage reservoir 26.

When the leak valve 22 is in an intermediate position between the fully open position and the fully closed position, the pressure delivered to the control chamber 13 is an intermediate pressure between the pressure of the first pressure source 21 and the pressure of the leakage reservoir 26.

According to a particularly advantageous embodiment of the invention, the displacement of the check valve 27 of the leak valve 22 is controlled by a control circuit 40 of the leak valve 22.

Said control circuit 40 of the leak valve 22 comprises a pneumatic regulator 31. Said pneumatic regulator 31 comprises, as shown in the figures, a membrane 32 delimiting two chambers, a regulating chamber 33 designed to be supplied with pressure, known as regulating pressure, and a calibrating chamber 34 comprising a calibrated spring 35 connected to the membrane 32. The position of equilibrium of the membrane depends 32 on the regulating pressure and on the stiffness of the calibrated spring 35. Said spring 35 may be of any type, for example a flat wire coil spring.

Such a regulator 31 also comprises a rigid rod 30 fixed to the membrane 32 and the check valve 27 of the leak valve 22.

Henceforth, a displacement of the membrane 32 causes a displacement of the check valve 27. The displacement of the check valve 27 thus depends on the regulating pressure delivered to the regulating chamber 33.

To achieve this, the control circuit 40 also comprises a pressure source, known as the third pressure source 28, at least one duct 15 arranged between the third pressure source 28 and the regulating chamber 33, and a leak valve 41 designed to create a leak in the duct 15 of the control circuit 40 which makes it possible to vary the pressure delivered to the regulating chamber 33.

Said leak valve 41 of the control circuit 40, according to an advantageous embodiment and as shown in the figures, is formed by an orifice 42 formed in the duct 15 and a mobile vane 43 arranged opposite said orifice 42. A displacement of the vane 43 ensures a variation in the leak cross section, and thus a variation in the regulating pressure delivered to the regulating chamber 33.

The displacements of this vane 43, according to one advantageous embodiment of the invention, are provided by an electric motor 7.

For example, the vane 43 may be mounted on the shaft of the electric motor 7 such that starting-up the motor shaft may provide a pivoting of the vane 43 by at least a few degrees so as to increase or reduce the leak cross section of the control circuit 40.

According to an advantageous embodiment of the invention, the pump further comprises a control unit 8 designed to supply an electric motor 7 with a command designed to cause a displacement of the vane 43. The displacement of the vane 43 makes it possible to modify the pressure delivered to the regulating chamber 33 of the regulator 31. Said pressure modification causes a displacement of the membrane 32. This displacement of the membrane 32 causes a displacement of the rigid rod 30. This displacement of the rod 30 causes a displacement of the check valve 27. This displacement of the check valve 27 makes it possible to modify the pressure delivered to the control chamber 13. This pressure modification causes a displacement of the stopper 12 in the duct 2. This displacement of the stopper causes a modification of the proportions of HP/IP gas in the mixing housing 1. This modification of the proportions causes a modification of the pressure of the outlet gas present in the region of the outlet duct 4.

The electric motor 7 is, for example, a torque motor designed to receive a continuous current command delivered by the control unit 8. The control unit is, for example, a control unit of a continuous current electric motor designed to deliver a continuous current in a range of a few mA to 350 mA.

The command supplied to the electric motor 7 by the control unit 8, makes it possible to carry out a regulation of the pressure of the pump according to this embodiment of the invention.

A pump according to this embodiment and as shown in the figures, further comprises a pressure sensor 45 arranged at the pump outlet and designed to deliver to said control unit 8 a signal, known as the pressure measuring signal, representative of the pressure of the gas present at the pump outlet. Said sensor 45 may be of any known type.

The control unit 8 is further designed to receive a reference signal via a connection 46. This reference signal may be representative of a reference pressure value which the pump has to provide at the pump outlet. The connection 46 may be a wired connection, a wireless connection and generally any type of connection designed to transmit an electric signal to a control unit.

The control unit 8 may now compare the value of the pressure supplied by the pressure sensor 45 and the value of the reference pressure and determine a motor command permitting the electric motor 7 to initiate the series of actions making it possible to modify the pressure at the pump outlet.

According to an embodiment of the invention, the actuator 10 comprises an actuator body 16 inside of which is housed the piston 11 fixed to the stopper 12. The actuator body 16 further comprises means for guiding the mobile piston 11 in free translation.

The actuator further comprises the control chamber 13 delimited by the body 16 and the mobile piston 11. Said control chamber 13 is provided with a spring 17 designed to exert on the mobile piston 11 a force which cooperates with the pressure delivered to the control chamber 13 via the pressurization duct 14.

The actuator also comprises a second chamber 18 opposing the control chamber 13 relative to the mobile piston 11. Said second chamber 18 is designed to be supplied with HP gas.

The position of the mobile piston 11 thus depends on the pressure in the control chamber 13, the stiffness of the spring 17 and the HP pressure of the second chamber 18.

FIGS. 3 and 4 show two examples of the relationship between the position of the check valve 27 of the leak valve 22 and the position of the mobile piston 11 of the actuator 10.

In FIG. 3, the check valve 27 is in a position in which the pressurization duct 14 is supplied directly with the high pressure of the pressure source 21. The control chamber 13 is thus supplied with said high pressure. The mobile piston 11 is thus in a fully deployed position. The stopper 12 thus carries out a maximum reduction of the passage section of HP gas toward the mixing housing 1, which makes it possible to reduce the pressure of the gas at the pump outlet.

In FIG. 4, the check valve 27 is in a position in which the leakage is at a maximum. The pressure delivered to the control chamber 13 is thus at a minimum. The difference in pressure between the control chamber 13, on the one hand, and the second chamber 18, accumulated in the dynamic field of pressure applied to the stopper 12, on the other hand, displaces the mobile piston 11 into a fully retracted position. The stopper is thus displaced into a position in which the passage section of HP gas toward the mixing housing 1 is at a maximum. The pressure of the gas at the gas outlet is thus increased.

The duct 2 and the stopper 12 may have different shapes.

According to an advantageous embodiment of the invention and as shown in the figures, the duct 2 for supplying the mixing housing 1 is conical and the stopper 12 is a conical needle valve which extends into said duct 2, so that a displacement of the stopper continuously modifies the passage section of HP gas toward the mixing housing 1.

A pump according to the invention permits the mixing of different gases at different pressures.

A pump according to the invention is particularly intended for being fitted in an air conditioning circuit of an aircraft. Henceforth, the HP gas is high pressure air drawn from the engines of the aircraft and the IP gas is air drawn from the cabin of the aircraft.

There is nothing, however, to prevent providing other sources of air to supply a pump according to the invention.

Similarly, the first, second and third sources of pressure may be of any type.

According to an advantageous embodiment of the invention, the first pressure source is the duct 2 in which the HP gas circulates, the second pressure source is ambient air in the vicinity of the pump, and the third pressure source is derived from the gas mixed at the pump outlet.

Said third pressure source is obtained, advantageously and as shown in FIG. 5, by means of a pressure reducing valve 48 designed to supply constant pressure from the pump outlet gas. Said pressure reducing valve 48 may be implemented by any known means to supply a reduced pressure from a source of high pressure or medium pressure.

A pump according to the invention may form the subject of numerous variants, not disclosed.

In particular, a pump according to the invention may comprise a plurality of leak valves and a plurality of motors for controlling said leak valves.

A pump according to the invention makes it possible to regulate precisely the pressure at the pump outlet. In particular, a pump according to the invention makes it possible to supply a constant pressure at the pump outlet from two sources of non-constant pressure.

A pump according to the invention thus makes it possible to limit the use of HP air drawn from the engines, which makes it possible, in particular, to limit the overconsumption of fuel. Moreover, as such a pump is intended to be fitted in an air conditioning system, it is possible to reduce the dimensions of the pre-cooler typically arranged between the engines of the aircraft and a primary heat exchanger.

A pump according to the invention also makes it possible to increase the power of the engines of the aircraft, the drawing of air therefrom being limited by such a pump.

A pump according to the invention also makes it possible to increase the service life of the engines of the aircraft, due to a reduction in the temperature caused by a reduction in air drawn in, which such a pump permits.

A pump according to the invention also permits a reduction in the weight of pneumatic equipment due to a greater pressure available when the aircraft engines are idling.

1-17. (canceled)

18. A gas—in particular air—mixing pump with variable injection section comprising:
a gas mixing housing,
giving into the mixing housing, a first duct for supplying the mixing housing with a gas, known as HP gas, brought to a first pressure,
giving into a mixing housing, a second duct for supplying the mixing housing with a gas, known as IP gas, brought to a second pressure which is different from said first pressure,
connected to the mixing housing, an outlet duct for the mixed gases, known as outlet gas, via the mixing housing, said outlet gas having an intermediate pressure between said first pressure and said second pressure which depends on the proportions of HP gas and IP gas delivered to the mixing housing,
a pneumatic actuator arranged in said first HP gas supply duct, the pneumatic actuator comprising:
a mobile piston connected to a stopper whose position in said first supply duct determines a passage section of the HP gas toward the mixing housing, a variation in the position of said piston causing a variation in said passage section,
a control chamber of said mobile piston fed under pressure via a pressurization duct, the pressure prevailing in the control chamber determining the position of said mobile piston,
a pneumatic circuit, known as the power circuit, provided between a pressure source, known as the first pressure source, and said pressurization duct, the power circuit being designed to deliver a pressure, known as the control pressure, to the control chamber via said pressurization duct,
wherein
the power circuit comprises at least one leak valve arranged between the first pressure source and the pressurization duct, adapted for generating a leak in the power circuit with an adjustable leak rate, the value thereof determining the pressure delivered to the control chamber of the pneumatic actuator, and in that it comprises:
an electric motor designed to permit the displacement of said leak valve between a position, known as the fully open position, corresponding to the maximum opening of the leak valve, and a position known as the fully closed position in which the pressure delivered to the control chamber is the pressure of said first pressure source,
a pressure sensor at the pump outlet and designed to deliver a signal, known as the pressure measuring signal, representative of the pressure of said outlet gas,
an electric control unit designed to receive a reference signal representative of a reference pressure value which the pump has to supply at the pump outlet, and the pressure measuring signal delivered by the pressure sensor, said electric control unit being designed to supply the electric motor with a command designed to cause an opening/closing of said leak valve(s), so as to modify the value of the pressure delivered to the control chamber so that said stopper may be displaced in said first duct, and so that the pump supplies, at the pump outlet, an outlet gas at said reference pressure.

19. The pump as claimed in claim 18, wherein said leak valve is a proportional valve designed to be able to be displaced continuously between said fully open position, corresponding to the maximum opening of the leak valve, and said fully closed position, corresponding to the maximum closing of said leak valve, so as to permit continuous variations of the leak flow rate.

20. The pump as claimed in claim 18, wherein it comprises:
a temperature sensor arranged at the pump outlet and designed to deliver a signal, known as the temperature measuring signal, representative of the temperature of said outlet gas,
an electric control unit designed to receive a reference signal representative of a reference temperature value which the pump has to deliver at the pump outlet and the temperature measuring signal delivered by the temperature sensor, said electric control unit being designed to supply the electric motor with a command designed to cause an opening/closing of said leak valve(s), so as to modify the value of the pressure delivered to the control chamber so that said stopper may be displaced in said first duct and so that the pump supplies, at the pump outlet, an outlet gas at said reference temperature.

21. The pump as claimed in claim 18, wherein said leak valve is a three-way valve: a first port connected to said pressurization duct; a second port connected to said first pressure source; a third port connected to a leakage reservoir, at a pressure which is lower than the pressure of said first pressure source.

22. The pump as claimed in claim 21, wherein said three-way leak valve comprises a check valve designed to be displaced continuously between a position corresponding to said fully closed position in which said first port is in direct communication with said second port, so that the pressure delivered to the control chamber is the pressure of said first pressure source and a position, corresponding to said fully open position, in which said first port is in direct communication with said third port so that the pressure delivered to the control chamber is the pressure of said leakage reservoir.

23. The pump as claimed in claim 22, wherein said electric motor is designed to permit the displacement of said check valve so as to ensure a variation in the pressure delivered to the control chamber of the actuator, which is an intermediate pressure between the pressure of said first pressure source and the pressure of said leakage reservoir.

24. The pump as claimed in claim 22, wherein it comprises a control circuit of said leak valve, said control circuit comprising a pneumatic regulator comprising:
a membrane delimiting two chambers, a regulating chamber designed to be supplied with pressure, known as the regulating pressure, and a calibrating chamber comprising a calibrated spring connected to said membrane, the position of equilibrium of said membrane depending on said regulating pressure and the stiffness of said calibrated spring,
a rigid rod connected to the membrane and to the check valve of said leak valve, so that a displacement of the membrane causes a displacement of the check valve.

25. The pump as claimed in claim 24, wherein the control circuit comprises:
a pressure source, known as the third pressure source,
at least one duct arranged between said third pressure source and said regulating chamber and designed to deliver to said regulating chamber a regulating pressure,
a leak valve designed to generate a leak in said duct of the control circuit which makes it possible to vary the regulating pressure delivered to said regulating chamber.

26. The pump as claimed in claim 25, wherein said leak valve of said control circuit is formed by an orifice made in said duct and by a mobile vane arranged opposite said orifice.

27. The pump as claimed in claim 26, wherein the electric motor is designed to ensure, upon a command of the control unit, a displacement of said vane so as to vary the pressure delivered to said regulating chamber of the regulator so as to permit an opening/closing of said leak valve of said power circuit.

28. The pump as claimed in claim 25, wherein said third pressure source of said control circuit is supplied by a pressure reducing valve designed to supply a predetermined pressure, from gas drawn from the pump outlet.

29. The pump as claimed in claim 25, wherein said first pressure source connected to said three-way leak valve is said HP gas.

30. The pump as claimed in claim 18, wherein said pneumatic actuator comprises:
an actuator body inside which is arranged said mobile piston, said actuator body comprising means for guiding said mobile piston in free translation,
delimited by said actuator body and said mobile piston, said control chamber,
delimited by said actuator body and said mobile piston opposing said control chamber, a second chamber designed to be supplied with said HP gas,
a closing spring arranged in said control chamber and designed to exert on said mobile piston a force which cooperates with said pressure delivered to said control chamber to ensure the displacements of said mobile piston.

31. The pump as claimed in claim 18, wherein the ducts for supplying HP gas and IP gas open concentrically into the mixing housing.

32. The pump as claimed in claim 18, wherein said HP gas is high pressure air drawn from the engines of an aircraft and said IP gas is air at internal pressure drawn from an aircraft cabin.

33. The pump as claimed in claim 18, wherein said first duct for supplying the mixing housing is conical and wherein said stopper is a conical needle valve which extends into said first supply duct.

34. The pump as claimed in claim 18, wherein said electric motor is a continuous current torque motor.

35. The pump as claimed in claim 19, wherein it comprises:
a temperature sensor arranged at the pump outlet and designed to deliver a signal, known as the temperature measuring signal, representative of the temperature of said outlet gas,
an electric control unit designed to receive a reference signal representative of a reference temperature value which the pump has to deliver at the pump outlet and the temperature measuring signal delivered by the temperature sensor, said electric control unit being designed to supply the electric motor with a command designed to cause an opening/closing of said leak valve(s), so as to modify the value of the pressure delivered to the control chamber so that said stopper may be displaced in said first duct and so that the pump supplies, at the pump outlet, an outlet gas at said reference temperature.

36. The pump as claimed in claim 23, wherein it comprises a control circuit of said leak valve, said control circuit comprising a pneumatic regulator comprising:
a membrane delimiting two chambers, a regulating chamber designed to be supplied with pressure, known as the regulating pressure, and a calibrating chamber comprising a calibrated spring connected to said membrane, the position of equilibrium of said membrane depending on said regulating pressure and the stiffness of said calibrated spring,
a rigid rod connected to the membrane and to the check valve of said leak valve, so that a displacement of the membrane causes a displacement of the check valve.
